(19) United States
(12) Patent Application Publication
(10) Pub. No.: US 2007/0130018 A1
(43) Pub. Date: Jun. 7, 2007

(54) Integrated intelligent seo transaction platform

(76) Inventor: Yasuo Nishizawa, Tokyo (JP)

Correspondence Address: JACOBSON HOLMAN PLLC, 400 SEVENTH STREET N.W., SUITE 600, WASHINGTON, DC, 20004, US

(21) Appl. No.: 10/585,119

(22) PCT Filed: Dec. 27, 2004
(86) PCT No.: PCT/JP04/19510

§ 371 Date: Jun. 30, 2006

(30) Foreign Application Priority Data
Jan. 5, 2004 (JP) 2004-000634

(51) Int. Cl. G06Q 30/00

(52) U.S. Cl. 705/26

(57) ABSTRACT

There is provided a system including a structuralizing HTML generation system having a Make robot for actually generating an optimal link system and generating an optimal page configuration. The system automatically causes a structuralizing HTML generation system to operate so as to realize an optimal SEO according to the analysis content based on the tracking result of a transaction with outside, generates an HTML content group structured optimally, and returns it to an external commerce display server, thereby enabling display of an optimal HTML structuralizing Web site at an external commerce server.

### TECHNOLOGY FIELDS

The invented technology is a system which enables to automatically execution of so called Search Engine Optimization(hereinafter referred to as “SEO”) in accordance with the tracking result, which enables the most efficient optimization of contents of a homepage in order to make the said contents be listed in the upper side at most in a result of a search engine.

Especially, this system enables execution of the most optimized SEO in a outside commerce site which does not contain contents for SEO in its own server, by an automatic method to activate the crawling system (Robot search engine activating a spider program and crawling a homepage.), manual method of CSV etc and by storing the HTML (Hyper Text Markup Language) contents, by interlocking the said structured HTML construction generation system, or by interlocking with the said transaction tracking system which is handles transaction from time to time.

This system also enables to display the said most optimized HTML structured home page on the said outside home page by returning the optimized page to the originated outside commerce server and to display the optimized HTML structured page on the web site of the said transaction platform operator.

That is, this is an application of the invention concerning a platform enabling execution of automatic SEO by transferring the link structure and page structure from time to time by synchronizing with dynamic pages through interlock with a database without necessity of changing the said home page system.

This invention also concerns a system enabling automatic transfer of the class structure of other multimedia contents of other instrument such as cellular phone etc in order to make the same class structure of structured HTML by the automatic SEO and concerns a system which enable interoperability of several display servers to enables several display methods in order to enhance marketing functionality.

### BACK GROUND ART

There are Existing E-Commerce and Internet Related Technology:

1) Affiliate System

There is a system having an affiliate engine to connect affiliate sites and contents provider sites for navigating many people from the said affiliate sites to contents provider sites and increasing transaction as much as possible. The system always measures the number of navigation and actual transaction volume.

Using this affiliate system, the affiliate engine always measures transaction volume, commonly charges to the contents providers fees in proportion to transaction volume, and pays the fee to affiliate sites.

The said affiliate sites intend not only to introduce more people to the said content provider sites but to try make such people do transaction including shopping, request for material documents, reservation, bidding, and inputting of data, as much as possible by several ways.

The affiliate engine operator executes payments of success commission in proportion to the transaction volume eventually made by such efforts of the affiliate sites.

2) Several Tracking Systems

Several technologies are invented to track transaction of a website after inducing many people to the web site. It is necessary to track sales transaction volume in case that the contents provider is an operator of E-Commerce such as an internet shopping mall. It is well known that there is such a system that some special program is installed in the sales processing server of the said E-Commerce system and the special program is supposed to send back the data to the affiliate engine and other systems.

Among such tracking systems, several systems are well known: One is a proxy type system which measures traffic at the proxy area of the affiliate site and can consistently handle and measure the signal data even after passing through the proxy.

Second system is a system which installs a tracking module inside the transaction handling portion inside the server of the contents provider side.

This tracking system sends the tracking signal data back to the contents provider server side in accordance with actual transaction volume.

Another easy tracking system is also known. The system can create cookie at the affiliate sever side, and contents provider side can handle transaction volume and send the corresponding signal back to the affiliate server side.

3) Closed Model Shopping Mall

This is a traditional and conventional shopping mall. That is, a tenant can open a shop store, place its own contents in the database of the mall server, operate the management page which can be accessed only by the shop, and know the sales and order information through sales transaction database of the server.

In this system, contents of the shop can be displayed as a part of the web site of the shopping mall by storing all shop related data such as contents, customer data, and order data by the database of the shopping mall. Several shopping malls strictly prohibit links from the shop page of the shopping mall to the outside of the shopping malls.

For example, E-Commerce operators are sometimes prohibited from making any linkage from shop page inside the shopping mall to its own homepage outside the mall. Thus, in the said closed model shopping, all transaction of order processing and sales data are completed in the shopping mall server.

4) Open Shopping Mall=Link Type Mall

On the other hand, some popular portal sites are link type malls which handle sales transaction outside the said mall by linking to shop's own site or other sites, different from the above mentioned closed mall. The well known Amazon.com and Yahoo Shopping Mall are comprised of the mixture of the above 3) mentioned Closed type shopping mall and this Link type mall.

That is, it is quiet common to create integrated shopping malls by mixing the Closed type which executes and stores all processes including contents, sales transaction the basket function), and transaction data inside the server of the shopping mall, and the link type mall which executes the related process and sales transaction (the basket function) and stores sales data inside the shop's own server outside the shopping mall.

5) SEO(Search Engine Optimization) Technology

Some convenient and superior search engines are well known today. Most consumers are accustomed to search appropriate home pages (websites) by inputting their interested words (keywords) into such search engines.

It is very much serious concern today for operators of the said commerce sites to have their homepage contents displayed in the highest position as much as possible as a result of searches at such sites, since such famous search engine sites have strong power to invite many people to their own sites which eventually lead to execute final sales transaction. The technology related to such a serious concern is called Search Engine Optimization (SEO).

Several technologies are generally called as SEO including a method utilizing a well known fact that a static simple HTML page is listed easier as a result of search engines or a fact that the more a page has links from pages with frequent access the more the page tends to listed in search engines.

However, the present SEO technology does not necessarily guarantee more accesses at search engines. Some of such technology is includes a variety of technology such as a technology integrated in the platform or merely intangible assets of know-how or other hypothetical technology.

6) AI (Artificial Intelligence) Utilized Electronic-Commerce Platform

E-Commerce Platform utilizing AI in detail is also well known as A shopping function platform. This AI based E-Commerce Platform includes a function which displays a commodity with frequent access in the apparent upper place in the site, or a function which gives a notice about the commodity to users, who have registered their ID information, by sending e-mails to their PCs or cellular phones or by activating an alert function which displays messages in the downloaded and installed tool or the mail dispatching function.

Or like some sheet reservation systems, the reservation situation is displayed from time to time in accordance with the said AI rule or condition, cooperating with conditions and rules stored in the hard disk.

7) HTML Structuring and Dynamic and Static Pages Integrating Management System

With regard to the above 5), there is a HTML structuring and dynamic and static pages integrating management system. This system displays the combination of two kinds of pages, dynamic pages consisting of database or other programs and static pages based on HTML pages, and used in order to solve the database transaction problems caused by heavy transaction concentrated onto the dynamic pages through huge access.

In case of a site composed mainly from dynamic pages generated from a database function, it is difficult to be listed in almost all search engines. However, if the “Dynamic and Static page integral control management system function” of the system is used, such a site is transformed to a mixture of dynamic pages and static pages so that the site can easily be an objective of SEO.

Moreover, if such a dynamic page with frequent access is changed to a static page and composed into an optimized tree link structure, the whole site can be transformed into a SEO appropriate structure.

In other words, without using such a system, it is difficult and costly to fundamentally restructure a site composed mainly from dynamic pages interlocking directly with database system to static base by manual. With this system, it is easy to change into an appropriate structure in balancing with SEO and database traffic.

8) Shopping Mall with Rich Marketing Functions

At present, there are some shopping malls with various full marketing functions. Almost all of these shopping malls are almost same as mentioned in the above 3), and a tenant shop can utilize a full line of marketing functions of these shopping malls once such a tenant opens a shop in the shopping mall. In such a case, the said tenant shop can utilize the “manager page” through authorized accesses and utilize various marketing functions as follows:

a) Mail Distribution:

It is possible to distribute marketing mails to all or a part of customers by utilizing the customer database stored in the shopping mall. Such a mail is called as “Melmaga” (Mail Magazine) and this function is Mail Magazine Distributing Function. Furthermore, some malls have the analyzing function which analyzes attribution or demographic data including who opens the mail, who responds to it, and who are lead to actual purchase.

b) Affiliate Function:

Some shopping malls have affiliate functions which provide affiliate site owners with a function and process to choose and appeal commodity of tenants and to sell them through the affiliate engine.

c) Integral Controlled E-Commerce Function with a Cellular Phone

At present, some shopping malls are constructed to enable integrally control input and output from both PC and other terminals to realize shopping from the both devices. That is, the shopping platform can be controlled integrally in the same way of PC, by various devices such as a cellular phone, PDA, TV, other electric appliances and other equipment which are all connected with the internet network.

d) Tracking Analyzing Function

A shopping mall is usually provided with an analyzing function to analyze the route of the customer traffic, action patterns, and purchase activities in detail.

e) SEO Function

Some shopping mall platforms have a function to enable SEO. However, this SEO technology includes both platform based technology and know-how of each individual. The know-how belongs to a shopping mall operator or to a tenant shop which holds its own contents inside the shopping mall, and each tenant shop has to endeavor to make SEO effective. Anyway, some shopping mall platforms have the SEO function to some extent so that each tenant can have more SEO effect than the case that they open a shop independently from such a mall.

9) Tracking System which Measures Actions of Users Over Linked and Navigated Site

Some shopping mall platforms have a tracking system which can measure and analyze the traffic of the users who go through from the mall site to the outside site, that is, measure and analyze how the users behave, which page they look into, and what kind of transaction the users make.

a) Proxy Type

The proxy type tracking system installed in the mall side server can track all behavior of the users navigated to a destination site through a hyper link from a portal site or link type shopping mall.

b) Installed Type

In this type, the tracking system is installed inside the transaction server of the content provider side, such as an E-Commerce operator. This installed system can track all detailed behavior of users and send such information back to the originated site. It needs a lot of work and time to install this type tracking system into the server.

### DISCLOSURE OF INVENTION

### Problem this Invention Tries to Solve

The Problem of the Closed Type Shopping Mall

The ordinal shopping mall is the closed type. Even in the case that shopping mall tenant has its own homepage, it is necessary to execute sales transaction processing and store the data at the shopping mall side independently and separately from the data or process at its own E-Commerce site. On the other side, the integrated linkage among shopping transaction processing and back-end transaction of corporate logistics including store management, distribution management, and account processing and corporate financial processing is becoming more and more important. However, it is going to be a serious problem to continue opening a shop at a closed shopping mall because the basket and sales database processing are executed in the shopping mall side independently and separately from its own site, although it is necessary to construct a shopping site which is perfectly linked with the corporate back-end logistic system.

From the view of shopping mall operators, it is convenient and advantageous for them to confine shop tenants inside the closed type mall by enforcing the tenants to use the shopping mall's basket system and not allowing them to use their own basket or other systems nor make any linkage from the contents of the shops to the outside.

However, some tenants wish to strengthen the linkage of the shopping system and their own customer database, corporate account system, store management system, transportation system, and corporate human resource.

More shops become unsatisfied with the current closed type shopping mall because of the limitation of the closed mall although such shops enjoy heavy traffic and people gathering power by aggregation content power of the shopping mall. In fact, such a closed type shopping mall does not have flexibility.

The Problem of the Independent Site

It is a burden to such companies to solve these problems only by themselves, which are related to the most advanced know-how in the E-Commerce field and the platform. Such know-how is growing and improving with amazing speed and it is difficult for each company to follow the speed by itself.

On the other hand, companies which are executing E-Commerce at their own homepage have problems as follows.

A) The Way to Prepare the Functions Necessary for E-Commerce Marketing

Mail distribution function and mail distribution analyzing function

Affiliate function: the way to hold many affiliate sites and how to construct affiliate networks

Customer gathering function: the way to construct and utilize functions such as auction, reverse-auction, and community system.

b) Most difficult problem: the way to gather customers most effectively.

c) Provision for SEO: the way to succeed in putting their own contents in the upper area of search engine results.

Problem Regarding SEO

(1) Linkage from a page having heavy traffic

1) Many ideas are necessary in the effort of putting their contents in the possible upper area of a result of search engines. However, some of the ideas are difficult to be realized by each independent homepage. Especially, the page displayed prior in search engines needs to have many link-in from heavy traffic pages outside of the homepage. It is difficult for a company which does not have own affiliate network to realize such a link-in by itself. That is, it is difficult for an independent company to visit a company which has heavy accessed homepages and obtain approval of linkage with its homepage, and more difficult to realize such processes with many sites.

2) Many methods are known to fulfill the SEO condition of 'having many linkages from heavy accessed pages by increasing access to the site inside contents and creating linkage from such contents pages. However, independent sites can realize few of them.

3) A shopping mall is effective to solve this problem. A shopping mall can have heavy access by ‘Mass aggregation effect’ provided by many tenants, which produces strong customer gathering power. For example, a link of a page requiring SEO effect with a frequent accessed top page fulfills the above mentioned 1) condition. This effect also can be obtained by a link with a heavy accessed page other than a top page. Such a linkage increases the possibility for contents to be listed in the above portion of a result of search engines.

(2) HTML conversion

a) It is more appropriate to convert a page to static HTML page in order to make the page be listed in search engines.

However, it is common to construct a homepage, especially E-Commerce site, by utilizing programs to produce dynamic pages with changeable data of the database. In such a case, a serious problem is caused that the dynamic page is quite difficult to be an object of search engines.

In such a case, it is necessary to convert some dynamic pages to static HTML pages and to keep the configuration of the original site by appropriate maintenance of the balance of the dynamic page and static page. For that purpose, ‘HTML constructing generation dynamic and static integration page control system’ is necessary. However, since this system usually needs several combinations of servers and needs large scale of the physical system, it is not realistic for each E-Commerce site to introduce this system because of its cost, time, and difficulty.

On the other hand, a shopping mall enables tenants to share such a cost and time for such a system even if it needs heavy configuration. Thus, in case the shopping mall has this ‘HTML constructing generation dynamic and static integration page control system’, each mall tenant can effectively construct HTML generation by utilizing this system economically and commonly. However, if an E-Commerce operator wishes to operate commerce business independently to execute HTML conversion by itself while it can not bear the cost of the system, the only solution has been the only solution.

b) Another way to convert a dynamic page to static page is known such as putting a html extension code after URL. However, such a way can not change the link structure for SEO purpose. Therefore, HTML conversion in this way is not suitable for the SEO effect. Again, preparing HTML constructing generation system by a shop itself needs hard work and cost. It has been a serious problem how a dynamic page site related with the database should be changed to a static page structure, keeping the original homepage structure without fundamental modification on the original system of the site.

The Problem of the Link Type Mall

In case of participating in the ‘Link type shopping mall’ which merely gathers linkage of independent sites with heavy traffic site such as ‘portal site’, such participant shops can certainly enjoy more traffic from the linked portal sites. However, concerning SEO or E-Commerce marketing functions, such participant shops in the linked type mall have to do everything by itself at its own site and the mall side can do little. That is, the mall side can do only limited works for SEO since such a mall does not contains contents inside the mall.

Since the sales transaction data is usually stored only in the each server side, marketing situation of each E-Commerce site of the said participant shop is completely independent from marketing function of the portal site or such a type of shopping mall. Therefore, a function to know the marketing situation of each site of the linked shop tenant is not provided since a mall merely intends to induce more traffic to the linked tenant shops. Even if such a function to measure the marketing situation of the tenant shop side is provided, the function to cooperate such data and SEO or other marketing function has not been provided with the link type shopping mall. Even if such cooperation is realized a little by manually, the link type shopping mall does not have the integration control function platform containing integrated SEO and other marketing function.

Problem Regarding Tracking

There are several types of tracking system. However, none of these systems does not have a function which automatically activates SEO or marketing function of the platform based on the measured data given from the tracking system. As described before, there are technique and know-how inside SEO technology which are realized previously only by manually based on the tracked data. Almost all platforms having such a tracking system do not have an automatic operation function.

It is necessary for a shopping mall operator or platform operator who provide platform functions to tenant participant shops or who wishes to increase transaction volume made through each tenant shop or their own E-Commerce site, to actively and promptly respond to the tracking data of the transaction or marketing situation of the tenant shops.

For example, if shopping mall operators obtain information that a specific commodity is selling well and that transaction volume is increasing rapidly in the linked site, they wish to sell the commodity by utilizing all mall functions. They wish to display the commodity in their shops as above as possible in search engines by utilizing SEO technology to increase sales opportunity. As of today, however, there is no such platform which enables such a dynamic linkage of SEO and sales situation.

Furthermore, there is no such SEO possible platform which automatically links with transaction volume of the induced and linked E-Commerce site and provides optimization technique. In such a current situation, primitive manual SEO work is the only option for such functions.

<The Method to Solve the Problems>

This invention is made for the purpose of solving the problems described above.

That is, Claim 1 is,

Integrated Intelligent SEO (Search Engine Optimization) Transaction Platform (hereinafter called “Transaction Platform”) comprising of,

Plurality of client personal computers connecting to Internet or Intranet;

WWW display server which displays WEB pages described in HTML in accordance with a request from the said client terminal;

said crawling system which automatically gathers contents of the outside commerce site (A) and inside commerce site (B) in the form of the same structured static HTML page by automatic tracing of the said contents from the top page of the said site and by analysis of the link structure of the said homepage and each page structure of the said homepage;

said tracking system which is intended to execute tracking transaction with the outside comprising display tracking system, transaction tracking system, proxy server, tracking analyzing server which analyzes and stores the said tracking data, and tracking analyzing database;

said HTML contents database storing static HTML contents maintaining its link structure which are gathered by crawling outside commerce site and/or by using offline media such as DVD, CD-ROM etc. from the said commerce site;

said database storing optimized structured HTML contents which possess the optimized structure based on the said HTML contents database;

said HTML constructing generation system comprising of the control manager, which integrally controls both dynamic contents and static contents to be generated each time in order to generate the said optimized structured HTML, a Make robot which actually generates the most optimized link structure and the most optimized page structure, a Put robot which outputs the said generated HTML contents being most optimized structured into the display server;

a group of display servers comprising of a mail server, affiliate engine system, mobile server, paid listing server, alert system server, multimedia display system, and call system;

said marketing control system which controls and displays for marketing purpose in the said structured HTML generation system and other said display server groups in accordance with automatic and manual input, based on the information from tracking analyzing server, in accordance with the rule recorded in the SEO (Search Engine Optimization) rule data base and marketing rule database; and

said system being characterized by enable to display the most optimized structured HTML contents group in the said site operated by the operator of the said transaction platform through the WWW display server, and simultaneously to display the said HTML contents as the optimized HTML structured homepage on the said outside commerce server by returning the optimized contents to the commerce display server of the said outside commerce server, after automatic generation of the most optimized structured HTML contents group by automatic operation of the said optimized HTML constructing generation system in accordance with the rule recorded in the SEO rule database, by automatic functioning of the automatic intelligent control system and actual operation of the most optimized SEO, based on the analyzing result from the tracking data, and by storing of the generated HTML contents.

Claim 2 is,

The system characterized by enabling HTML optimization by activating the said crawling function and gathering HTML contents into inside of the said platform by equally handling both the outside commerce site (A) and contents included in the inside contents of the said commerce site (B) stored inside said transaction platform.

Claim 3 is,

The system characterized by enabling generation of the most optimized structured HMTL contents by making the said platform manage and control the said transaction volume of the said commerce site by means of the interlocking tracking module and tracking system, and by functioning the said control system in order to maximize the marketing effect at most based on the analyzed result in accordance with rules and the manual instruction and order after simultaneously delivering the analyzed tracking data to the marketing control system.

Claim 4 is,

The system characterized by automatically executing the optimized HTML constructing generation in order to execute SEO automatically in accordance with the previous memorized SEO related rule, by automatically analyzing actual tracking data from time to time, while holding a manual operation function:

Claim 5 is,

The system characterized by capability to automatically execute the most optimized HTML structuring in order to make the said homepage contents be object of search engines as much as possible, by automatically tracking all marketing related data including opening ratio of the said mail, navigation ratio from affiliate sites, occurring transaction number, response ratio from mobile terminals, response ratio and/or transaction ratio from the alert system and response ratio from multimedia terminals including PDA and digital TV, and response ratio against the paid listing service.

Claim 6 is,

The system characterized by capability to automatically transform the multimedia contents to be displayed in the mail or alert system in accordance with the structure of the SEO executed HTML contents displayed on WWW, and by transmitting the contents to the said several display server group which are transformed in HTML contents and stored in the multimedia contents database.

Claim 7 is,

The system characterized by capability to create the most optimized combination of dynamic pages and static pages and to change the link structure and to automatically change the page structure by using template pages or by manual operation, by systematically and closely interoperate the HTML constructing generation system, tracking analyzing system, and marketing control system, in order to increase the possibility to make specific pages of the said homepage site be object of the outside search engine.

Claim 8 is,

The system characterized by capability to increase the possibility to make a specific page of a homepage site by manually or automatically changing the link system structure of the said commerce site and by changing the status of mixture of both dynamic pages and static pages, and by changing the page structure by adopting a template, in accordance with the said rule database storing rule gained through the existing know-how and tracking system measuring transaction volume of the said commerce site.

Claim 9 is,

The system characterized by capability to display the said homepage site as the most optimized HTML structured home page by returning the said transformed optimized structured HTML contents to the commerce display server of the outside commerce server after transmitting the said homepage of the outside commerce site by means of the said crawling system and the said HTML constructing generation system, and by capability to transfer the dynamic page system by synchronizing with transferred link system through the instruction to the commodity database system at the outside commerce site in case that the said HTML constructing generation system transfers the link structure for SEO purpose.

### EFFECT OF THE INVENTION

This invention can solve the defect of the closed mall which is one of the problems described above. Participating in a closed mall means that an E-Commerce operator has to get its own contents out of its own homepage and has to put them into the database of the transaction platform of the shopping mall while sales transaction data is controlled in the transaction process server of the shopping mall side. However, by utilizing this invented platform, an E-Commerce operator can keep its operation like ‘Outside Commerce site’.

That is, it is possible to integrally control both outside commerce site and inside commerce site in the same way by utilizing the automatic crawling system of the said transaction platform and retrieving the content automatically from the said outside commerce, and storing the HTML contents in the HTML contents server of the platform. The HTML contents stored in the HTML contents database are transformed into the most optimized structured HTML and inputted to the WWW displayed server. By utilizing this function, the E-Commerce operator can independently keep operation using its E-Commerce system which is linked with the accounting system, storage management system, or logistic system as they are. At the same time, the operator can enjoy the merit of SEO technology by participating in a shopping mall.

Such functions provide a large merit to the E-Commerce operator because the operator can utilize the SEO technology of the said transaction platform without starting separate operation in the closed mall and with keeping their own operation independently outside the shopping mall.

This invention also solves the problem of ‘defect of the link type model’ and ‘limit of the tracking system’. That is, in case of the link type model, which is merely enables a linkage but the contents exist outside the platform, the SEO effect is limited since the transaction platform operator can not change contents by itself and only can operate the link point at its own site.

But utilizing the crawling technology and HTML constructing generation system of this invented system, it is possible to store the same structured HTML contents after storing the static HTML contents produced by systems from both dynamic page and static page so that it is possible to execute SEO technique on the transformed HTML pages which keep the link structure. By this way, it is possible to solve the limit of the open type mall, that is, link type mall.

Usually, the tracking system is installed in the linked outside commerce server and merely communicates with the outside transaction platform such as shopping mall intends tracking only. With such a usual tracking system, marketing adjustment at the platform side is possible only by manually and human judgment. Even if automatic adjustment is possible, it is limited only to the interaction with an alert system or mail system to announce the situation, but to execution of the SEO technique with automatic cooperation with the tracking data.

This invented system can solve such a limitation of the tracking system and solve the defect of the open type platform by interlocking the tracking result with the marketing control system and automatically transforming the structure of the contents in the best SEO manner.

This invented system can solves the serious problem of the independent homepage operator and commerce operator, that is, the problem that the independent operator can not develop or execute by itself all necessary marketing technique such as SEO. This system can also solve the problem that link from a prominent site is required and that the HTML constructing generation system can be held only by a big commerce site due to its heavy cost.

The problem of operating double E-Commerce sites, that is, their own independent sites outside the platform and the inside sites of the platform which have different baskets, was described in detail before. However, the system of this invention does not require such double operation. This invention makes it possible to place their own contents inside the said transaction platform such as shopping mall outside E-Commerce sites in the same way of the inside E-Commerce sites operated inside the transaction platform and pay attention only to their own operation at their own sites. By utilizing the transaction platform, E-Commerce operators can keep independent operation outside the mall timely in accordance with the tracking data so that the best HTML structuring of their own homepage is realized. Also, the best structured HTML transformed homepage can be displayed on the homepage of the transaction platform operator. Thus, it is possible to transform their own sites and display the transformed HTML contents also onto the site. This invention also enables outside E-Commerce site operators to display structured HMTL contents in flexible and various ways even though they do not have their own transaction platform.

Outside E-Commerce operators can concentrate on operation of their own homepage, adopt SEO technology, and use various several marketing know-how included in the said transaction platform by participating in the platform.

Even if there is a system which has a function to transform homepage contents and the page structure at the outside E-Commerce site, such a system before this invention enables only to superficially transform the page but to transform the page flexibly and timely in synchronizing with the database. This invented transaction platform is featured by the HTML constructing structuring system and is featured by generating both static page and dynamic page in an integrated method which maintains the page structure. This system can change database of related commodity in harmonizing with the link structure and page structure and maintain both the dynamic page structure and static pages by interlocking with the said commodity database. This invention solves the existing problems regarding integrity of dynamic pages and static pages.

### THE BEST MODE FOR CARRYING OUT THE INVENTION

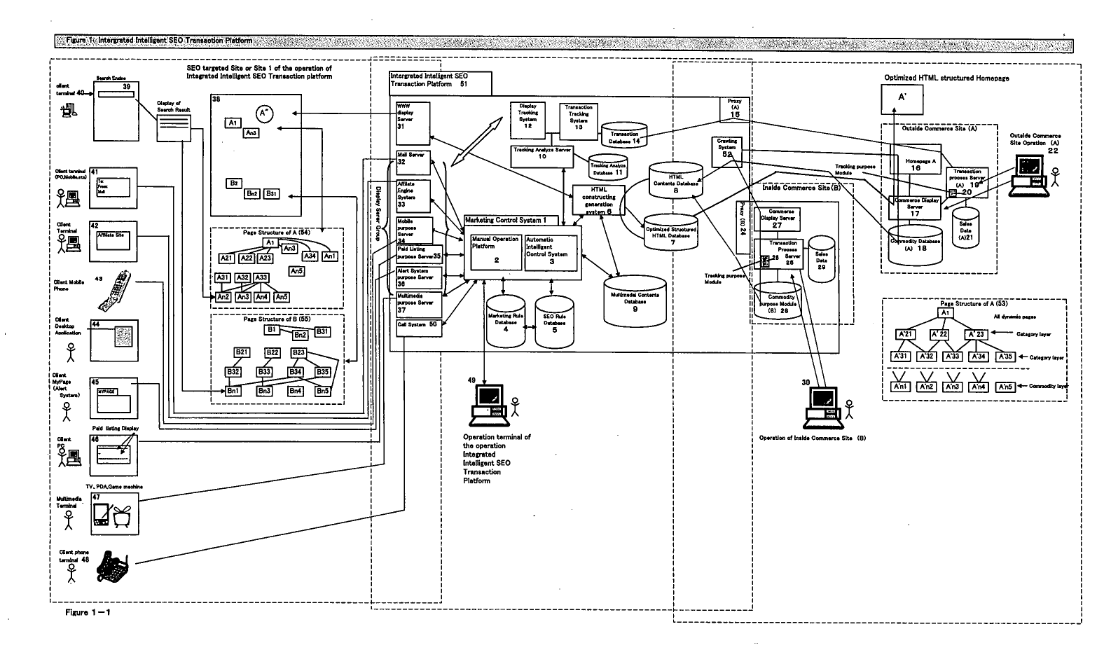

In FIG. 1, Integrated Intelligent SEO Transaction Platform (hereinafter referred as ‘Transaction Platform’) 51 is essential of this invention. The outside commerce site (A) is a homepage like an E-Commerce site which intends and enables transaction such as shopping, download sales, material request, and auction. This site makes it possible to produce the said transaction by operating programs and contents included in the outside commerce site (A) server by the outside commerce operator terminal 22.

The said commerce site stores contents inside the commodity database 18 using the client terminal 22 of the operator, activates the commerce display server 17 to activate the said homepage 16, processes the produced transaction at the transaction process server 19, and stores the result inside the sales database 21.

The transaction process server 19 is the processing part. For example, the server executes basket process at the shopping site and bidding and tendering process at the auction site.

The tracking module 20 which timely tells the transaction volume can be installed to the said transaction platform 51 in the transaction process server. By this installation, it is also possible to interlock the SEO function and many other marketing functions. Thus, this module 20 can generate and transmit necessary signals in accordance with the transaction volume. For example, at a shopping site, sales amount is returned back to the said platform as transaction volume. Then the transaction module 20 transmits the tracking result to the said transaction platform 51 by interlocking with the proxy 15 inside the said transaction platform 51.

The Inside Commerce Site (B) operates inside the said transaction platform 51 by placing the necessary server or contents inside the said transaction platform 51. For example, in case this transaction platform 51 is a shopping mall, E-Commerce sites can open their shops as shopping mall sites by renting the shopping functions of the transaction platform in a popular way well known as ASP. In this case, E-Commerce operators can operate commerce without preparing all necessary functions such as marketing or shopping functions by themselves.

The Inside Commerce site operator (B) inputs and stores its contents into the commodity database 28 inside the said the transaction platform 51 through its own client terminal 30. These input contents are displayed in the SEO executed site 38 through a worldwide web server (hereinafter referred as WWW) by a function of the said transaction platform and interlocked with the commerce display server 27.

The transaction produced at the said process server is memorized and stored in the sales database 29. The transaction volume occurring in the Inside Commerce site (B) can be grasped by access to the transaction process server 25 from the operator's client terminal 30. Tracking module 26 is installed in the said transaction process server 25 in order to timely and periodically grasp the transaction occurring in the said transaction process server 25 by interlocking with the said transaction platform 51. The module 26 can timely transmit the transaction to the said transaction platform 51 through proxy (B) 24.

The Inside Commerce site (B) and Outside Commerce site (A) transmit occurring transaction to the transaction tracking system 13 through the proxy 15 or 24. The display tracking system 12 is a system for always measuring through WWW displayed server 31, on which contents are accessed and from which the access are made.

The transaction tracking system 13 is a system for gathering the tracking result of the transaction of both the Inside Commerce site (B) and Outside Commerce site (A), and transmits the result to the tracking analyzing server 10.

The tracked transaction result is memorized and stored in the transaction database 14 by the process of the transaction tracking system 13. The analyzed result of the tracking analyzing server 10 is memorized and stored in the tracking analyzing database 11.

The contents of the Outside Commerce Site (A) are automatically gathered from the homepage 16 by the crawling system 52 and memorized and stored in the HTML contents database 8. The crawling system 52 is the system for gathering the HTML contents from outside homepages by automatically and/or partially manually analyzing the pages. This system plays an important role for the transaction platform 51 to store any HTML converted contents after transformation of both outside and inside sites into HTML pages in the database. The crawling system 52 is the system to enable to obtain related data by automatically entering inside of the outside commerce site (A), by tracing the link structure of the page, and by analyzing the dynamic pages by displaying each page. The system can gather all HTML contents by maintaining the link structure of the said outside commerce site.

All contents are stored in the HTML contents database 8, by the function of crawling system 52 regarding the outside commerce site (A), and by HTML contents stored in the commodity databases 28 of the said platform regarding the Inside commerce site (B).

In this case, the Outside Commerce site (A) and the said platform operator 22 may agree each other upon that the said outside commerce site (A) may deliver its own contents to the platform side not by the automatic crawling on the contents stored in the commodity database 18. Or the outside commerce site (A) may pass its contents by the off-line media such as DVD or CD-ROM. The essence of this invention keeps same notwithstanding the way of delivering its own contents, and the following process is not changed after the HTML contents are stored in the HTML contents database.

After containing transformed HTML contents in the HTML contents database 8, the HTML constructing generation system 6 can generate HTML contents pages which maintain the same link tree structure of the dynamic pages and static pages and generate optimized link structured pages. That is, the link structure of a homepage can be transformed to the optimized link structure in order to make the page listed as a result of outside search engines. The HTML constructing generation system prepares several types of template pages. For example, the system can generate new HTML pages using this template system so that the pages can be listed by search engines with higher possibility.

The HTML constructing generation system can generate pages by changing the structure appropriately in accordance with the instruction from the marketing control system 1.

For example, in case that the control system 1 sends an instruction to change a page including some specific word so that the page shall be listed in search engines with higher possibility, the said HTML generation system 6 can change the page in order to optimize its page structure and link structure.

The marketing control system 1 has the automatic intelligence control system 3 and manual operation platform 2 for execution of manual instructions. The automatic intelligence control system automatically and intelligently judge and control in accordance with previous experience and know-how included in the marketing rule database 4 and SEO rule database 5 so that the transaction volume of both the outside commerce site (A) and Inside commerce site (B) can be maximized.

In case the tracking analyzing server 10 recognizes that the transaction at the outside commerce site (A) and inside commerce site (B) is smaller or larger than the predefined access volume or transaction volume, this invented system can execute the function to increase output or disclosure in accordance with a method included in the database. For example, it is possible to increase the disclosure and display in various types of media such as cellular phone, alert system, TV terminal, mail, affiliate network, etc. This system also can execute more appropriate SEO method on the contents in accordance with the SEO rule included in the SEO rule database in responding to the said tracking analyzing result.

When the transaction volume become larger or smaller in the Outside commerce site (A) and Inside commerce site (B), a SEO rule can be defined and memorized, which defines how to increase or decrease SEO effect in accordance with the difference between the transaction volume and commodity value.

In case the display tracking system 12 judges that a specific commodity is gaining more attention and being referred more frequently than a specific volume, a rule is memorized to define how to increase SEO possibility of the commodity, category pages, or pages including relevant commodity to be listed in search engine results.

For example, SEO execution is requested in case a commodity should be listed as a result of search engines regarding a specific word to obtain specific access and transaction volume. In such a case, a rule is defined previously so that the said category pages and related pages including the commodity are linked with heavy traffic pages such as the top page of a homepage. Such a rule is stored in the SEO rule database 5, and a judge is made in the said marketing control system 1, and HTML constructing generation system 6 works based on the control result.

The said transaction platform 51 is used as a popularly known shopping mall platform and has a group of display servers to enable the marketing function to output and display the contents to various types of media. That is, this system has a whole set of display servers including the mail server 32 for distributing mail, affiliate server 33 for output and display on an affiliate site, mobile contents server 34 for output to a mobile terminal such as a cellular phone and PDA terminal, paid listing purpose server 35 for display and output of the contents to the ‘return for result type’ paid listing server, alert system purpose server 37 for alerting to client terminal, multimedia display server 37 for displaying in television and multimedia terminal, call system 50 for automatically calling.

The marketing control system 1 can execute SEO based on the tracking analyzing data and can operate so that each display server can output contents for disclosing the contents much more effectively by each display server.

The marketing rule database 4 includes a rule and know-how regarding the way to disclose contents based on the tracking data. The marketing control system 1 can execute the best display method at each display channel based on the analyzing data referring to the said databases 4 and 5, mainly by the automatic intelligence control system 3.

The said control system 1 generates optimized contents to each display method by cooperating with the HTML constructing generation system 6 and stores the generated contents in the said multimedia content database 9.

The said marketing control system 1 retrieves stored contents generated for each display method from each multimedia contents database 9 and pushes the stored contents to the set of display servers of each display method and makes each display server display the contents.

For example, in case a tracking analyzing data reveals a specific commodity increases its transaction volume or frequency at the outside commerce site (A) or inside commerce site (B), the HMTL constructing generation system 6 generates the most optimized link structure or optimized page structure if such a rule is defined to effect more disclosure in several display methods in the rule databases 4 and 5.

The marketing control system 1 generates contents corresponding to several multimedia methods by synchronizing with the behavior of the HTML constructing generation system. The said multimedia contents are output and displayed in the display servers of the said multimedia contents based on the rule database.

The operator of the transaction platform 51 (hereinafter referred as “the operator”) can manually instruct to the system based on the tracking data through the operation terminal 49. That is, the operator can manually instruct the manual operation platform 2 of the marketing control system 1.

This can compensate and modify the shortcoming of the automatic function of the intelligence control system 3. It also enables the operator to change the display method in case the operator judges to ignore the automatic result made by the determined rule stored in the database.

For example, in case the automatic SEO function of the transaction platform 51 chooses to change the site structure into a specific link structure while the operator judges and decides to choose another link structure, the operator can manually operate the manual operation platform 2 through the said operation terminal.

The function of WWW display server 31 and all sets of several display servers of the transaction platform 51 can display contents to a client in various ways including the search engine site 39 at ordinal computer terminal 40, mail display 41 at client terminal, display of affiliate site 42 at client terminal, client mobile terminal 43, desk top application 44 at client PC, the alert display part 45 of My page of client PC, Paid listing display 46 of client terminal, multimedia terminal 47 of TV, PDA, Game etc., and client phone terminal 48. The said transaction platform 51 has a merit that it can consistently maintain several multimedia display methods even in case of changing the link structure by SEO.

The FIG. 53 of the page structure of the outside commerce site (A) shows a case that only the top page contains static HTML contents and all other lower layer pages are dynamic pages produced by interaction of a program and database.

On the other hand, the figure of the page structure 54 shows the case that all pages of outside commerce site (A) are transformed into all static pages.

Thus, it is possible to restructure a homepage link structure by optimizing the mixture of dynamic pages and static pages.

That is, this system can display a site in all static pages by generating a whole set of static pages beforehand and by storing the generated HTML contents in the database of the said platform 51 by the crawling system 52. Also, the Inside commerce site (B) can be transformed beforehand into the static pages and structure as shown in the structure (54)

Or based on a request of outside commerce site (B) or arrangements with the said transaction platform 51, some site operators may wish to display their own sites in the form of the HTML structured homepages 6 which is optimized in terms of SEO by the function of the said transaction platform.

In such a case, the commerce display sever 17 of the outside commerce site (A) can display the optimized HTML structured homepage (56) made by the HTML constructing generation system 6, upon the structured HTML contents stored in the most optimized HTML structured database 7.

Or in case that the outside commerce site (A) is the structure (53) comprised mainly from dynamic pages, it is possible to construct a truly convenient site for users by mixing with the static HTML construction structure (56).

The transaction platform 51 can not only display in the site 38 but also return the optimized structured transformed HTML of the outside commerce site (A) to its own site.

It means the said outside commerce site (A) can utilize the said transaction platform 51 and transform its site into the SEO optimized transformed structured homepage even if the site (A) does not have its own HTML constructing generation system.

In case that the said homepage 16 of the outside commerce site (A) is transformed to optimized HTML structured homepage (56) by the said transaction platform 51, the HTML constructing generation system 6 can appropriately instruct the said database 18 so that the data or information regarding a dynamic page or commodity to be stored in the database should be also appropriately updated or changed in accordance with the transformed HTML structure.

This function is one of the essential characteristic features of this invention. The function of the said transaction platform 51 to enable integral control of the page structure, HTML constructing link structure, and related databases in order to keep consistency of dynamic pages and static pages generated by the HTML constructing generation system is very much important.

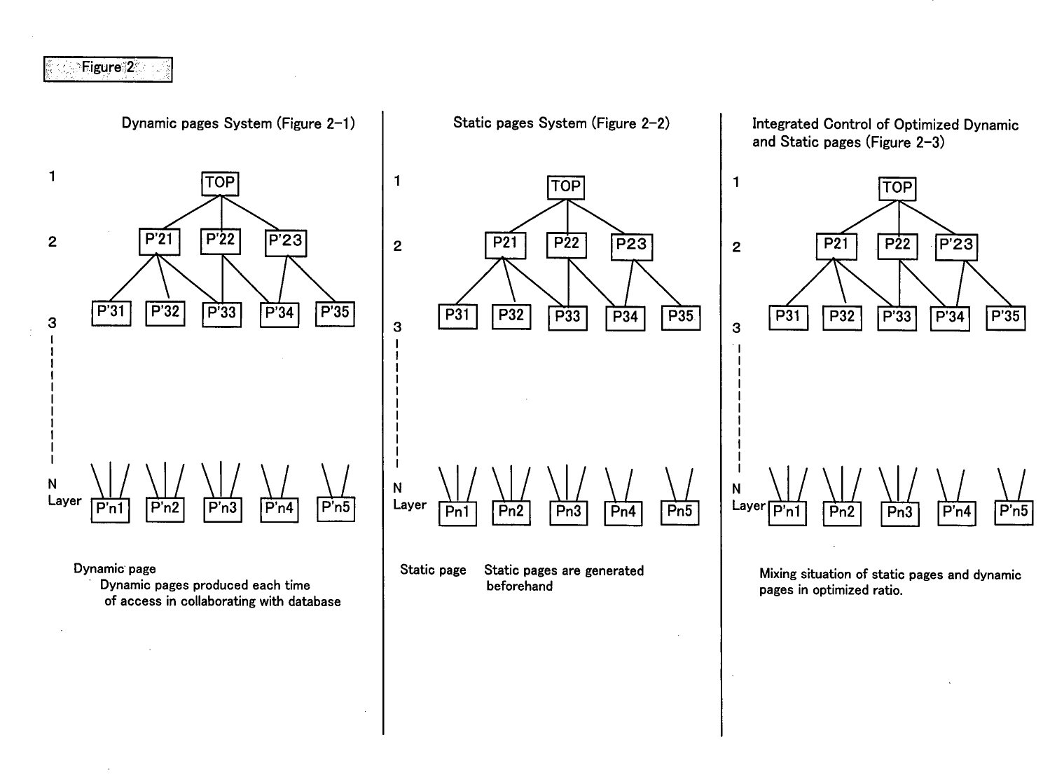

FIG. 2 shows the activity of the HTML constructing generation system.

This figure shows how the said system 6 can generate the most appropriate mixing situation, that is, how the integrated control of dynamic pages and static pages can be realized.

FIG. 2-1 shows the original behavior of a site which produces and displays dynamic page P′ₙₘ (nm is a natural number) cooperating with contents of the database. FIG. 2-2 shows the situation where the static HTML page Pnm is generated and structured by the said HTML constructing generation system 6 in accordance with the corresponding structure of the dynamic page P′ₙₘ.

The HTML constructing generation system 6 makes the site into a mixture of both dynamic pages P′ₙₘ and static pages Pₙₘ by transforming some pages into static pages and by intentionally leaving some dynamic pages as they are. It is not necessarily appropriate to change all pages into static pages. The optimistic balance of dynamic pages and static pages should be decided in various ways considering its purpose, environment, and situation.

However, considering search engines, it is well known that the ordinal HTML contents of static pages can be object of almost all search engines easier than dynamic page P′ₙₘ. For this purpose, a way is known to create static HTML content Pₙₘ one by one beforehand and put them on the WWW display contents server.

By this process, the possibility for the static contents page Pₙₘ to be listed in search engines is increased. The effect of the process is not limited to this SEO purpose. The process also contributes to reducing the system configuration since the server of the site does not need to produce dynamic pages from database each time when access is occurring. That is, the process reduces the burden of the database since the system need not produce dynamic pages each time, and has a merit that the system need not display other than static HTML pages Pₙₘ, s.

On the other hand, in case that the site does not have so much access or does not need to produce and display so many kinds of pages, it is not necessary or appropriate to produce static page Pnm beforehand. In such a case, it is more appropriate not to change dynamic pages and just to maintain the same site structure of dynamic page P_{′nm}.

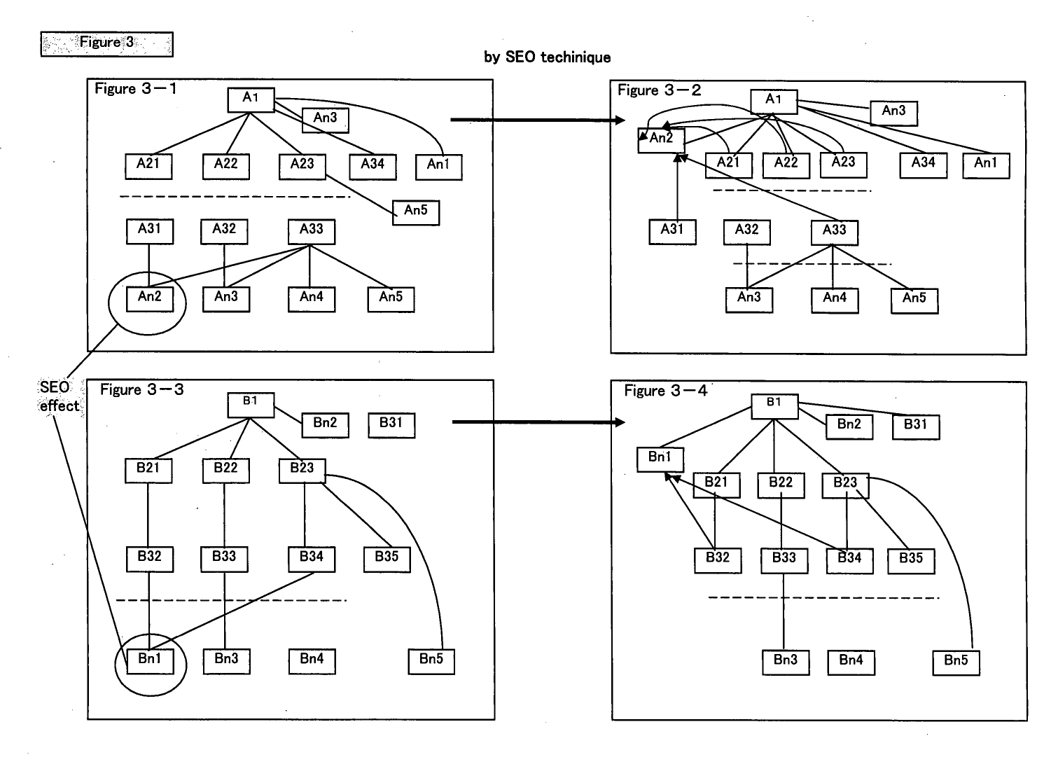

Due to the above reasons, the best optimized mixed structure of dynamic pages and static pages should be considered. The concrete structure is decided in terms of situation, estimated access, and purpose. FIG. 2-3 shows a sample of such a mixing situation.

For example, in FIG. 2-3, P′₂₃ is left as a dynamic page. Suppose the case that page P′₂₃ estimates heavy traffic, it is appropriate to generate corresponding page P₂₃ beforehand and place it in the same link structure of FIG. 2-3.

Or in a case that the commodity described in the dynamic page P′₃₄ is estimated to obtain more attention and this page is requested to be object of search engines, it is more appropriate from the point of view of SEO, to transform this page into the static HTML page P₃₄ beforehand, since a static page can be more easily targeted by search engines than a dynamic page.

Furthermore, in order to increase the priority of a specific page inside a homepage, link-in from more important pages is more required. Therefore, a work is required such as linking with a top page, a page having large access in the site, or affiliate sites through an affiliate network which the said site participates in.

In this invention, the HTML constructing generation system 6 can execute flexible work in changing the link structure and mixing the structure of these dynamic pages and static pages by controlling mixing situation of both dynamic page P′ₙₘ and static page Pnm in accordance with necessity and requirement by SEO.

This configuration change is automatically executed by following the rule and also manually done by following judges and decisions of the operator. As mentioned above, in changing the configuration in order to increase the priority of the said page in the whole homepage structure and to increase possibility to be an object of search engines, the system can automatically increase link-in to the pages from many related sites (affiliate sites etc). If increasing access volume of the said page is considered as the effective way to increase the possibility of SEO, the marketing control system above mentioned in detail can work effectively to increase the disclosure of the said contents of the said page through many display channels.

FIG. 2 explains the important work of HTML constructing generation system 6 of this invention and most optimized mixing situation of static and dynamic pages.

FIG. 1 explains in the structure (53) that the outside commerce site (A) is originally comprised of all dynamic pages except the top page. In FIG. 2, the said transaction platforms 51 transforms the page structure to the structure (54) comprised of all static HTML pages Aₙₘ. In the inside commerce site, the structure (55) is shown as an example which is comprised of all static pages Bₙₘ.

FIG. 3 explains the concrete transformation of the link structure by using commerce sites (A) and (B), as one of the important ways of increasing SEO possibility to be an object of search engines as much as possible.

For example, FIG. 3-2 shows an example of changing the link structure through this invention. In this case, the page Aₙ₂ is requested to increase SEO effect, that is, to increase the possibility to be listed in search engines. In this case, the page Aₙ₂ is linked with the most important page A₁ in the whole homepage structure. Furthermore, the page Aₙ₂ is linked from other important pages such as A₂₁, A₂₂, A₂₃. By this way, it is possible to increase the priority of the said page and to increase SEO possibility as a search engine object.

In FIG. 3-3, suppose to make the homepage Bₙ₁ of the inside commerce site be an object of SEO effect of search engines and increase SEO effect on that page.

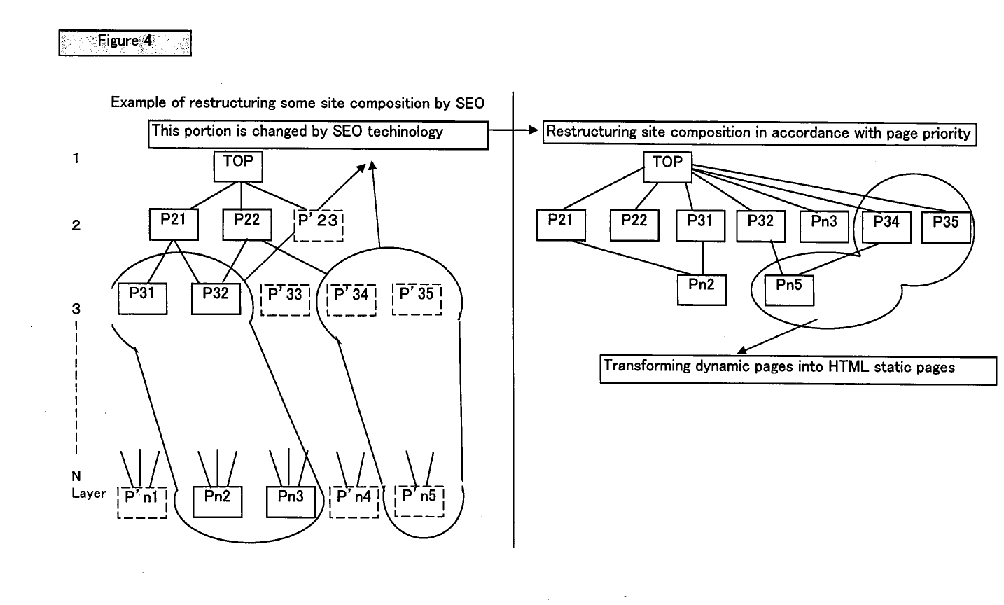

The link structure can be changed to the structure described in FIG. 3-4 by using the said transaction platform. That is, the homepage Bₙ₁ is linked from the top page B₁ and from other important pages such as B₂₁, B₂₂, B₂₃. By creating such linkage, it is possible to increase SEO possibility of the targeted page.

In addition to FIGS. 1, 2, and 3, FIG. 4 shows another example of changing the link structure combination by utilizing this invented system.

For example, in FIG. 4, the pages with ′(a dash) are dynamic pages and the pages without ′(a dash) are static pages. Suppose we wish to execute SEO effect on the pages P₃₁, P₃₂, Pₙ₂, Pₙ₃, P′₃₄, P′₃₅, P′ₙ₅, that is, to try to increase the possibility to be listed in search engine results.

FIG. 4-2 is the example to show, a dynamic page P′ₙₘ is transformed into a static page Pₙₘ by using the transaction platform 51 of FIG. 1, and its link structure is changed in accordance with the priority of the SEO intended page.

That is, this system transforms high priority pages to have links with higher priority pages. Thus, it is possible to change the possibility of search engine optimization by automatically transforming dynamic pages to static pages and changing the page structure of the static pages by using a part of the invented functions.

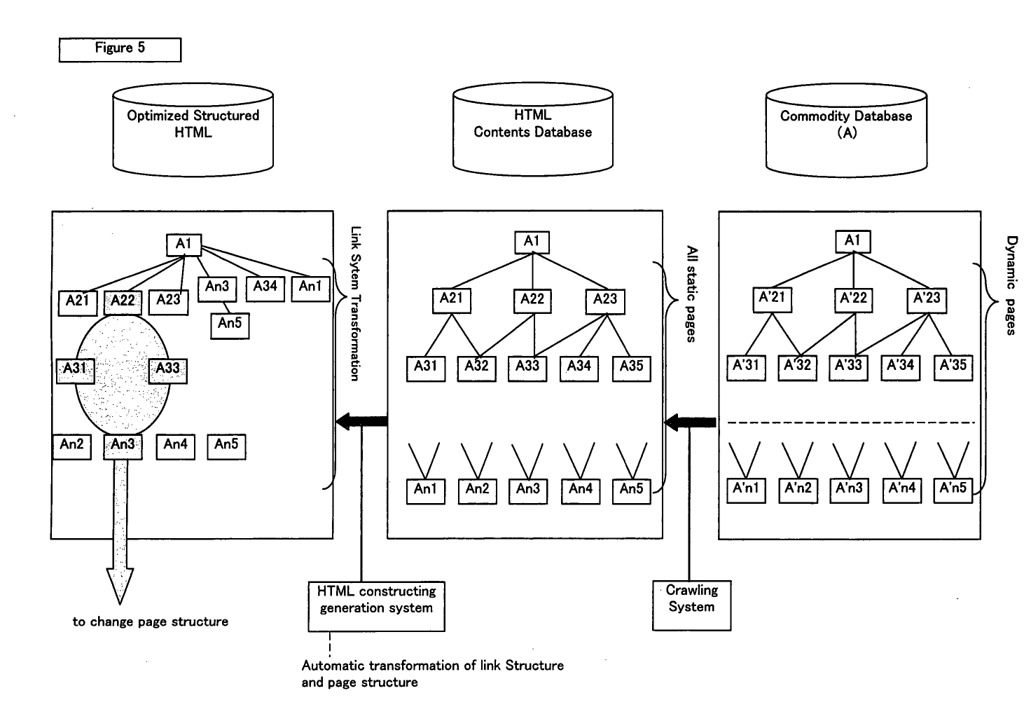

FIG. 5 shows a situation of the outside commerce site (A) stored in each database. The outside commerce site (A) outside the said transaction platform 51 is dynamic condition and stored in the commodity database (A) 18 in the form of dynamic page. The crawling system 52 of the said transaction platform 51 automatically analyzes the said homepage 16 and gathers related data from commodity database 18 (I,II), and store the data in the HTML contents database 8 in the form of static page (III)

Upon the link structure of static pages stored in the HTML contents database 8 in the transaction platform 51, the HTML constructing structure system 6 executes the automatic link structure transformation and page structure transformation simultaneously for SEO, following the instruction of the marketing control system 1.

As a result of this execution, the link structure transformed pages and construction transformed pages are stored in the database 7 of the optimized structured HTML database 7 (V).

In respect of the homepage 16 of outside commerce site (A), there are two cases (A) and (A′). The case (A′) is that the optimized HTML structured contents are transformed by the said transaction platform 51 and returned back to the original outside commerce site (VIII,XI). Another case (A″) is that the transformed HTML structured contents are displayed in the site of the operator of the transaction platform 51 (X)

That is, the crawling system 52 automatically analyzes the homepage 16 of the outside commerce site (A) and retrieves the contents into the said platform 52 (52 to 18). The contents are stored in the HTML contents database 8 (III) and transformed to the optimized HTML structured contents by a MAKE robot of the HTML constructing generation system 6 (IV), and the result is stored in the optimized HTML structure database 7 (V). At the same time, the robot dispatches the instruction to change commodity data of the outside database 18 in consistency with the optimized HTML structure (VI).

And the optimized structured HTML contents produced by the MAKE robot are sent to a Put robot for putting the contents to the display server (VIII).

Put robot pushes the HTML contents to the designated display server (VIII). However, if an instruction is provided, the transformed HTML contents are returned to the commerce display server of the said outside commerce site and displayed as the optimized HTML structured homepage (A′) (XI).

It is also possible to display the HTML contents on the operator's site of the said platform if there is such an instruction. In this case, the HTML contents are sent to the WWW display server of the transaction platform (X).

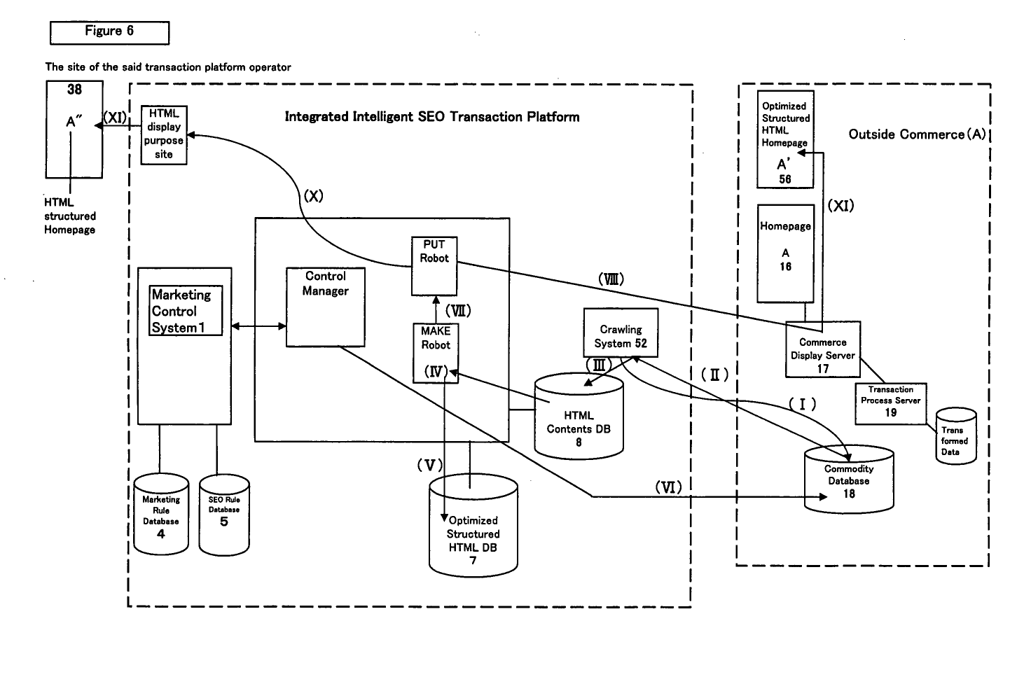

In FIG. 6, the function of the crawling system 52 of the said transaction platform gathers HTML contents together with its link structure from the platform 51. However, if there is mutual understanding or consensus between the outside commerce operator and transaction platform operator, it is also possible to deliver own contents of the outside operator by various off-line media such as CD-Rom and DVD etc.

Even in such a case, the HTML contents are stored in the HTML contents database 8 together with the link structure. Even in the case, the essence of this invention is maintained.

### INDUSTRIAL APPLICABILITY

The way to gather more customers to its own site or to effectively appeal its site to more people are very much important for an operator who creates transaction inside its web site and endeavors to appeal its site for more access. For that purpose, a lot of methods are known such as marketing mail, utilizing affiliate network, utilizing alert system, utilizing paid listing advertisement, utilizing mobile environment like cellular phone, or utilizing multimedia such as television other than personal computer (hereinafter referred as “PC”).

Among these various methods, inducing people by search engines which are used most frequently all over the world is very important. Therefore, the technology and know-how about how to make own site to raise the possibility of being listed as a search engine result, that is, SEO effect, are very much important.

However, such know-how regarding SEO is difficult and composed of so many methods that it is impossible to learn all of them by their own efforts. A platform has been expected for a long time, in which a commerce site can utilize the SEO know-how and increase the SEO possibility of being listed in the search engine results just by participating in the platform.

Also expected for long has been a platform that enables SEO effect on the said site without fundamental change to the system of the site.

A shopping mall has been known for long which rents shopping functions to tenant shops and gathers many shops to create portal site by aggregating such contents and utilizing the power of gathering customers. Some of such shopping malls are made with consciousness of SEO necessity which can transform contents into HTML pages and make them as a search engine object. However its technology level is primitive.

For example, such a shopping mall enables only primitive operation such as links with top pages by manual in order to increase SEO possibility.

Such shopping malls do not provide automatic SEO execution such as automatic changes of the link structure in responding to the page priority from time to time.

Regarding a shopping platform containing SEO function or other marketing functions, only a shopping platform exclusive for the inside commerce site has been provided. Therefore, in such a shopping platform, SEO is possible only to the shop contents of the inside commerce site. That is, in order to make their own contents be the object of search engines by using the SEO function of such a platform, the independent commerce site needs to get its contents from its own site and to place them into the platform of the shopping mall. Such double operation of the independent site and inside commerce site simultaneously has been a serious problem, as described above.

This invention solves these problems fundamentally and brings very much effective solutions. That is, an outside commerce site can integrally control the basket function and sales transaction database at its own homepage without using the separate basket of the shopping mall working independently from its own site or without putting separate data in the database inside the platform of the operator such as shopping mall operator.

It is also possible for a commerce site comprised of dynamic pages and composed around the database system to execute optimized HTML structuring for SEO purpose by utilizing the said transaction platform without any modifications to its site.

This invented platform is absolutely different from the shopping mall consisted of linked contents only. As mentioned above, flexible change to the page link structure is one of important SEO technology. However, in case of a link type shopping mall, only changing the link structure is less sufficient for SEO effect than changing own homepage since the changeable contents as SEO objects are limited in the said site. Furthermore, the ordinal link type shopping mall does not contain a function that enables the automatic SEO technology in responding to the tracking data of the transaction volume occurring in the outside commerce site.

In this invention, it is possible to execute SEO technology even onto the outside commerce site without changing the page structure by appropriate execution of HMTL optimization which is operated away from the transaction platform, almost in the same way of the inside commerce site.

It is also possible to execute HTML structuring and to display the transformed contents in each terminal of the system in order to collaborate SEO and other marketing methods of the marketing control system, that is, systematic activating tracking system, intelligent crawling system, and rule database of the know-how.

This invention also makes it possible to display the transformed contents in the said outside commerce site in the form of optimized HTML page link structure by transformation of the outside commerce site. The existing technology has had a problem that transforming HTML pages only superficially makes discrepancy from dynamic pages produced based on the commodity database each time. On the other hand, this invention enables to consistently maintain the balance of the generated static pages and dynamic pages by updating and changing the contents of the commodity database at the same time when the system transforms the HTML contents.

By utilizing the functions of this invention, outside commerce can manually or automatically execute the most optimized SEO structuring on its own site in executing update of the commodity database.

In case an outside operator wishes to maintain independent operation without placing its own contents on the site of the transaction platform operator and wishes to concentrate on operating its own site, a large scale system for SEO execution is generally necessary. For example, heavy work and cost are required merely for preparing the HTML constructing generating system in its own site. On the other hand, an outside operator participating in this invented platform can execute fundamental transformation of the site structure without changing the site operation system and organization mainly comprised of dynamic pages, since this invention has a crawling system and function which automatically enables to change transaction database in synchronizing with generated static pages.

It is necessary to systematically collaborate know-how stored in the rule database and tracking system for controlling various types of marketing display method. Therefore, the function of the marketing control system is very much important. The invented transaction platform can demonstrate its intelligent, automatic, and integrated marketing power by utilizing the function.

For example, when SEO is automatically executed for transformation of the page structure, the corresponding mobile site should also be transformed in accordance with the SEO execution. Such a multidimensional synchronization is realized by the function of this invented system.

Thus, by utilizing the invented transaction platform and effectively activating the automatic and systematic marketing functions, it is possible to increase the transaction volume, which is one of the transaction operator's general objectives.

The outside commerce site operator utilizing the function of the transaction platform can increase the transaction volume at maximum, by utilizing ample know-how aggregation of the shopping mall function while keeping the independent position outside the platform.

This invented system is a transaction platform which contains ample marketing functions required hereafter, provides various fundamental solutions relating to complicated SEO, and automatically and manually executes effective marketing purpose measurement in accordance with the tracking transaction volume occurring outside and inside the commerce site.

There has never been such an integrated transaction platform which totally manages various display methods in accordance with each display channel and simultaneously executes SEO measurement. Since E-Commerce is more prospering, this kind of platform is should become much more important.

### BRIEF DESCRIPTION OF THE DRAWINGS

[FIG. 1] The outline chart about the invented system

[FIG. 2] The outline chart of HTML structuring and behavior of the HTML constructing generation system

[FIG. 3] The Figure showing transformation of the homepage link structure by SEO technology function

[FIG. 4] The Example of page structure transformation by SEO

[FIG. 5] The Figure showing behavior of the crawling system and HTML constructing generation system

[FIG. 6] The Figure showing the relationship among the HTML constructing generation system, outside commerce site homepage (A), optimized HTML structuring homepage (A′), and the homepage on a site of the said platform operator (A″).

### EXPLANATION OF THE NUMBER

1 Marketing Control System
2 Manual Operation Platform
3 Automatic Intelligence Control System
4 Marketing Rule Database
5 SEO rule database
6 HTML constructing generation system
7 Optimized structuring HTML database
8 HTML contents database
9 Various type multimedia contents database
10 Tracking Analyze server
11 Tracking Analyze database
12 Display Tracking System
13 Transaction Tracking System
14 Transaction Database
15 Proxy (A)
16 Homepage (A)
17 Commerce Display Server
18 Commodity Database (A)
19 Transaction process server (A)
20 Tracking module
21 Order database (A)
22 Terminal of Outside Commerce site (A)
24 Proxy (B)
25 Transaction sever
26 Tracking module
27 Commerce display server
28 Commodity Database (B)
29 Order Database (B)
30 Terminal of Inside Commerce site
31 WWW display server
32 Mail server
33 Affiliate Engine System
34 Mobile server
35 Paid Listing server
36 Alert System server
37 Multimedia server
38 SEO object site
39 Search Engine Site
40 Client Terminal
41 Client Terminal
42 Client Terminal
43 Client mobile terminal
44 Client Desk Top Application
45 Client My page
46 Paid Listing display of Client terminal
47 Multimedia terminal
48 Client telephone terminal
49 Operation terminal of operator
50 Call system
51 Integrated Intelligence SEO transaction Platform
52 Crawling System
   Abstract
   <Summary>
   <Purpose>

To create and provide a system which can most appropriately transform a homepage of a commerce site into the optimized balance of dynamic pages and static pages in accordance with the designated rule, in order to make the pages to be more possibly listed in the upper portion of search engine results.

<Solution Method>

Integrated Intelligent SEO (Search Engine Optimization) Transaction Platform (hereinafter called “Transaction Platform”) comprising of,

Plurality of client personal computers connected to Internet or Intranet;

WWW display server which displays WEB pages described in HTML in accordance with a request from the client terminal;

said crawling system which automatically gathers contents of the outside commerce site (A) and inside commerce site (B) in the form of the same structured static HTML page by automatically tracing the said contents from top page of said site and by analyzing link structure of the said homepage and each page structure of the said homepage;

said tracking system which is intended to execute tracking transaction with the outside comprising display tracking system, transaction tracking system, proxy server, tracking analyzing server which analyzes and stores the said tracking data, and tracking analyzing database;

said HTML contents database storing static HTML contents maintaining its link structure which are gathered by crawling outside commerce sites and/or by using off-line media such as DVD, CD-ROM etc. from the said commerce site;

said database storing optimized structured HTML contents which possesses the optimized structure based on the said HTML contents database;

said HTML constructing generation system comprising of the control manager, which integrally controls both dynamic and static contents to be generated each time in order to generate the said optimized structured HTML, a Make robot which actually generates the most optimized link structure and the most optimized page structure, a Put robot which outputs the said generated HTML contents being most optimized structured into the display server;

a group of display servers comprising of mail server, affiliate engine system, mobile server, paid listing server, alert system purpose server, multimedia display purpose system, and call system;

said marketing control system which controls and displays for marketing purpose in the said structured HTML generation system and other said display server groups in accordance with automatic and manual input, based on the information from tracking analyzing server, in accordance with the rule recorded in the SEO (Search Engine Optimization) rule data base and marketing rule database; and

said system being characterized by being able to display the most optimized structured HTML contents group in the said site operated by the operator of the said transaction platform through the WWW display server, and simultaneously to display the said HTML contents as the optimized HTML structured homepage on the said outside commerce server by returning the optimized contents to the commerce display server of the said outside commerce server, after automatically generating the most optimized structured HTML contents group by automatically operating the said optimized HTML constructing generation system in accordance with the rule recorded in the SEO rule database, by automatically functioning the automatic intelligent control system and actually operating the most optimized SEO, based on the analyzing result from the tracking data, and by storing the generated HTML contents.

1. Integrated Intelligent SEO (Search Engine Optimization) Transaction Platform (hereinafter called “Transaction Platform”) comprising of;
Plurality of client personal computers connecting to Internet or Intranet;
WWW display server which displays WEB pages described in HTML in accordance with a request from the said client terminal;
said crawling system which automatically gathers contents of the outside commerce site (A) and inside commerce site (B) in the form of the same structured static HTML page by automatically tracing the said contents from the top page of the said site and by analyzing link structure of the said homepage and each page structure of the said homepage;
said tracking system which is intended to execute tracking transaction with outside comprising display tracking system, transaction tracking system, proxy server, tracking analyzing server which analyzes and stores said tracking data, and tracking analyzing database;
said HTML contents database storing static HTML contents maintaining its link structure which are gathered by crawling the outside commerce site and/or by using off-line media such as DVD and CD-ROM from said commerce site;
said database storing optimized structured HTML contents which possesses the optimized structure based on the said HTML contents database;
said HTML constructing generation system comprising of the control manager, which integrally controls both dynamic and static contents to be generated each time in order to generate the said optimized structured HTML, a Make robot which actually generates the most optimized link structure and the most optimized page structure, a Put robot which outputs the said generated HTML contents being most optimized structured into the display server;
a group of display servers comprising of a mail server, affiliate engine system, mobile server, paid listing server, alert system purpose server, multimedia display purpose system, and call system;
said marketing control system which controls and displays for marketing purpose in the said structured HTML generation system and other said display server groups in accordance with automatic and manual input, based on the information from the tracking analyzing server, in accordance with the rule recorded in SEO (Search Engine Optimization) rule data base and marketing rule database; and
said system being characterized by enabling to display the most optimized structured HTML contents group in the said site operated by the operator of said transaction platform through the WWW display server, and simultaneously to display the said HTML contents as the optimized HTML structured homepage on the said outside commerce server by returning the optimized contents to the commerce display server of said outside commerce server, after automatically generating the most optimized structured HTML contents group by automatically operating the said optimized HTML constructing generation system in accordance with the rule recorded in SEO rule database, by automatically functioning the automatic intelligent control system and actually operating the most optimized SEO, based on the analyzing result from the tracking data, and by storing the generated HTML contents.

2. The system according to claim 1 characterized by enabling HTML optimization by activating the said crawling function and gathering HTML contents into inside of said the platform by equally handling both the outside commerce site (A) and contents included in the inside contents of the said commerce site (B) stored inside the said transaction platform.

3. The system according to claim 1 being characterized by enabling to generate the most optimized structured HMTL contents by making the said platform manage and control the said transaction volume of the said commerce site by means of the interlocking tracking module and tracking system, and by functioning the said control system in order to maximize the marketing effect at most based on the analyzed result in accordance with rule and the manual instruction and order after simultaneously delivering the analyzed tracking data to the marketing control system.

4. The system according to claim 1 characterized by automatically executing optimized HTML constructing generation in order to automatically execute SEO in accordance with memorized SEO related rule, by automatically analyzing actual tracking data from time to time, while holding manual operation function:

5. The system according to claim 1 being characterized by capability to automatically execute most optimized HTML structuring in order to make the said homepage contents be object of search engines as much as possible, by automatically tracking all marketing related data including opening ratio of the said mail, navigation ratio from affiliate sites, occurring transaction number, response ratio from mobile terminals, response ratio and/or transaction ratio from alert system and response ratio from multimedia terminal including PDA and digital TV, response ratio against the paid listing service.

6. The system according to claim 1 characterized by capability of automatic transformation of the multimedia contents to be displayed in a mail or alert system in accordance with structure of SEO executed HTML contents displayed on WWW, and by transmitting the contents to the said several display server group which are transformed in the HTML contents and stored in the multimedia contents database.

7. The system according to claim 1 characterized by capability to create most optimized combination of dynamic and static pages, change link structure, and automatically change page structure by using template pages, by manual operation, or by systematically and closely interoperating HTML constructing generation system, tracking analyzing system, and marketing control system, in order to increase the possibility to make the specific pages of a homepage site be object of the outside search engines.

8. The system according to claim 1 characterized by capability to increase the possibility to make a specific page of the a homepage site by manually or automatically changing the link system structure of said commerce site and by changing the status of the mixture of both dynamic pages and static pages, and by changing the page structure by adopting template, in accordance with the said rule database storing rules gained through the existing know-how and tracking system measuring transaction volume of the said commerce site.

9. The system according to claim 1 characterized by capability to display a homepage site as the most optimized HTML structured home page by returning the said transformed optimized structured HTML contents to the commerce display server of the outside commerce server after transmitting said homepage of the outside commerce site by means of the said crawling system and the said HTML constructing generation system, and by capability to transfer the dynamic page system by synchronizing with transferred link system through the instruction to the commodity database system at the outside commerce site in case that the said HTML constructing generation system transfers the link structure for SEO purpose.
